(19) United States
(12) Patent Application Publication
(10) Pub. No.: US 2006/0212290 A1
(43) Pub. Date: Sep. 21, 2006

(54) Audio coding apparatus and audio decoding apparatus

(75) Inventor: Hiroyasu Ide, Fussa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/378,655

(22) Filed: Mar. 16, 2006

(30) Foreign Application Priority Data
Mar. 18, 2005 (JP) 2005-079464

(51) Int. Cl. G10L 19/14

(52) U.S. Cl. 704/229

(57) ABSTRACT

An audio coding apparatus comprises a frequency converting unit which performs a frequency transformation, a band dividing unit which divides a frequency band of frequency transformation factors into sub bands, a band width of the sub bands being narrower for a lower frequency sub band and wider for a higher frequency sub band, a retrieving unit which retrieves one of the frequency transformation factors for each sub band which has a maximum absolute value, a shift number calculating unit which calculates a shift bit number so that the one frequency transformation factor retrieved for each sub band is not more than a quantization bit number that has been determined in advance in each sub band, a shift processing unit which performs a shift processing for the shift bit number with respect to the frequency transformation factors, and a coding unit which encodes the shifted frequency transformation factors.

### CROSS-REFERENCE TO RELATED APPLICATIONS

This application is based upon and claims the benefit of priority from prior Japanese Patent Application No. 2005-079464, filed Mar. 18, 2005, the entire contents of which are incorporated herein by reference.

### BACKGROUND OF THE INVENTION

1. Field of the Invention

The present invention relates to an apparatus for coding an audio signal and an apparatus for decoding the coded audio signal.

2. Description of the Related Art

In recent years, as the music distribution by the Internet and digitalization of various recording media for recording an audio signal are progressed, an audio coding technology to compress the data amount of an audio signal is indispensable. As such an audio coding technology, Japanese Patent Application KOKAI Publication No. 7-46137 describes an audio coding technology according to a property of an auditory sense of human being. According to this prior art, a coding is made in such a manner that an audio signal is divided into a plurality of sub bands (a frequency band), the highest value (a scale value) and an allowable noise level N based on a critical band of a property of an auditory psychology are determined for each sub band. Then, an S/N ratio required for each sub band is determined, and a quantization bit number is calculated from this S/N ratio.

However, according to such an audio coding technology, many calculation steps are required for calculating the quantization bit number, so that this involves a problem such that the calculation volume is huge and the processing at a high speed cannot be realized.

### BRIEF SUMMARY OF THE INVENTION

An object of the present invention is to improve the processing efficiency of the voice processing according to a property of an auditory sense of a human being.

According to an embodiment of the present invention, an audio coding apparatus comprises:

a frequency converting unit which performs a frequency transformation with respect to an input audio signal;

a band dividing unit which divides a frequency band of frequency transformation factors which are obtained by the frequency transformation performed by the frequency converting unit into sub bands, a band width of the sub bands being narrower for a lower frequency sub band and wider for a higher frequency sub band;

a retrieving unit which retrieves one of the frequency transformation factors obtained by the frequency transformation performed by the frequency converting unit for each sub band which has a maximum absolute value;

a shift number calculating unit which calculates a shift bit number so that the one frequency transformation factor retrieved for each sub band by the retrieving unit is not more than a quantization bit number that has been determined in advance in each sub band;

a shift processing unit which performs a shift processing for the shift bit number that is calculated by the shift number calculating unit with respect to the frequency transformation factors obtained by the frequency converting means; and

a coding unit which encodes the frequency transformation factors that are shift-processed by the shift processing unit.

According to another embodiment of the present invention, an audio decoding apparatus comprises:

a decoding unit which decodes a coded audio signal including a shift bit number for each of sub bands of frequency transformation factors and a coded frequency transformation factor, the sub bands being obtained by dividing a frequency band of the frequency transformation factors, a band width of the sub bands being narrower for a lower frequency sub band and wider for a higher frequency sub band;

a shift processing unit which shifts the frequency transformation factors decoded by the decoding unit in a direction opposite to a direction upon coding by the decoded shift bit number; and

a frequency inverse converting unit which performs a frequency inverse transformation with respect to the frequency transformation factors shifted by the shift processing unit into a signal in a time domain and outputs the signal.

According to another embodiment of the present invention, an audio coding method comprises:

performing a frequency transformation with respect to an input audio signal;

dividing a frequency band of frequency transformation factors which are obtained by the frequency transformation into sub bands, a band width of the sub bands being narrower for a lower frequency sub band and wider for a higher frequency sub band;

retrieving one of the frequency transformation factors obtained by the frequency transformation for each sub band which has a maximum absolute value;

calculating a shift bit number so that the one frequency transformation factor retrieved for each sub band is not more than a quantization bit number that has been determined in advance in each sub band;

performing a shift processing for the calculated shift bit number with respect to the frequency transformation factors; and

encoding the shifted frequency transformation factors.

According to another embodiment of the present invention, an audio decoding method comprises:

decoding a coded audio signal including a shift bit number for each of sub bands of frequency transformation factors and a coded frequency transformation factor, the sub bands being obtained by dividing a frequency band of the frequency transformation factors, a band width of the sub bands being narrower for a lower frequency sub band and wider for a higher frequency sub band;

shifting the decoded frequency transformation factors in a direction opposite to a direction upon coding by the decoded shift bit number; and

performing a frequency inverse transformation with respect to the shifted frequency transformation factors into a signal in a time domain and outputs the signal.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing a configuration of an audio coding apparatus according to a first embodiment of the present invention;

FIG. 2 is a block diagram showing a configuration of an audio decoding apparatus according to the first embodiment of the present invention;

FIG. 3 is a view explaining the band division of a frequency transformation factor;

FIG. 4 is a view explaining a quantization bit number and a shift bit number;

FIG. 5 is a flow chart showing the audio decoding processing to be carried out by the audio decoding apparatus according to the first embodiment of the present invention;

FIG. 6 is a flow chart showing the audio decoding processing to be carried out by the audio decoding apparatus according to the first embodiment of the present invention;

FIG. 7 is a block diagram showing a configuration of an audio coding apparatus according to a second embodiment of the present invention;

FIG. 8 is a block diagram showing a configuration of an audio decoding apparatus according to the second embodiment of the present invention;

FIG. 9 is a flow chart showing the audio decoding processing to be carried out by the audio decoding apparatus according to the second embodiment of the present invention; and

FIG. 10 is a flow chart showing the audio decoding processing to be carried out by the audio decoding apparatus according to the second embodiment of the present invention.

### DETAILED DESCRIPTION OF THE INVENTION

An embodiment of an audio coding apparatus and an audio decoding apparatus according to the present invention will now be described with reference to the accompanying drawings.

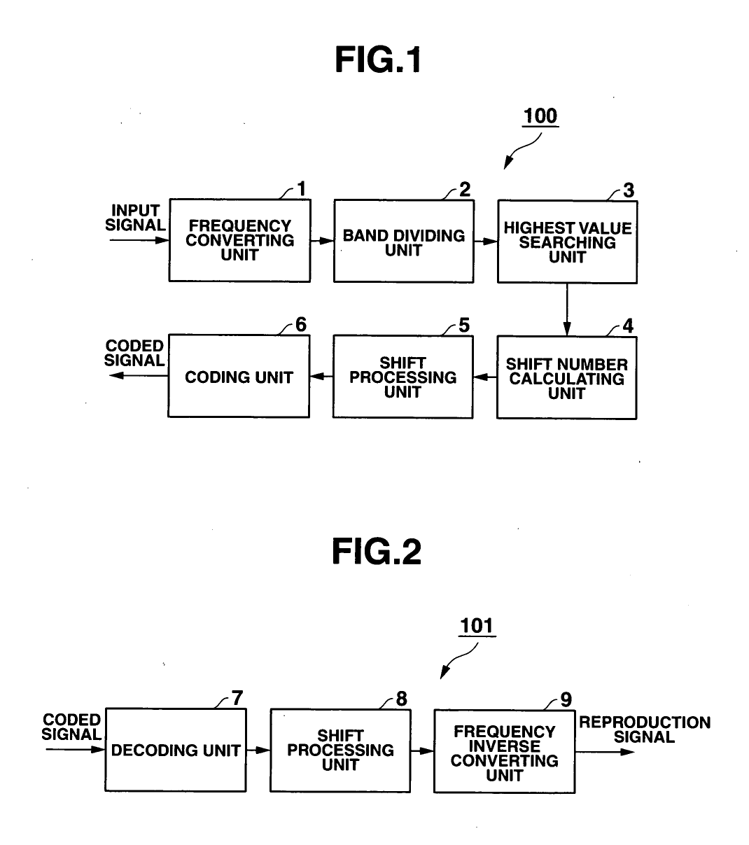

FIG. 1 shows a configuration of an audio coding apparatus 100 according to a first embodiment of the present invention. The audio coding apparatus 100 comprises a frequency converting unit 1, a band dividing unit 2, a highest value searching unit 3, a shift number calculating unit 4, a shift processing unit 5, and a coding unit 6.

The frequency converting unit 1 performs a frequency transformation with respect to the input audio signal to convert the input signal in a time domain to a signal in a frequency domain. The frequency converting unit 1 outputs a frequency transformation factor to the band dividing unit 2. As the frequency transformation of the audio signal, modified discrete cosine transform (MDCT) is used. Assuming that the input audio signal is {Xₙ|n=0, . . . , M−1}, a MDCT factor (a frequency transformation factor) {Xₖ|k=0, . . . , M/2−1} is defined as the following formula (1).

$${X}_{k} = {\sum }_{n = 0}^{M - 1} {x}_{n} \cdot {h}_{n} \cdot cos \{ \frac{2 π}{M} ( \frac{k + 1}{2} ) ( n + \frac{M}{4} + \frac{1}{2} ) \} \qquad ( 1 )$$

Here, hₙ is a window function and it is defined as the following formula (2).

$${h}_{n} = sin \{ \frac{π}{M} ( n + \frac{1}{2} ) \} \qquad ( 2 )$$

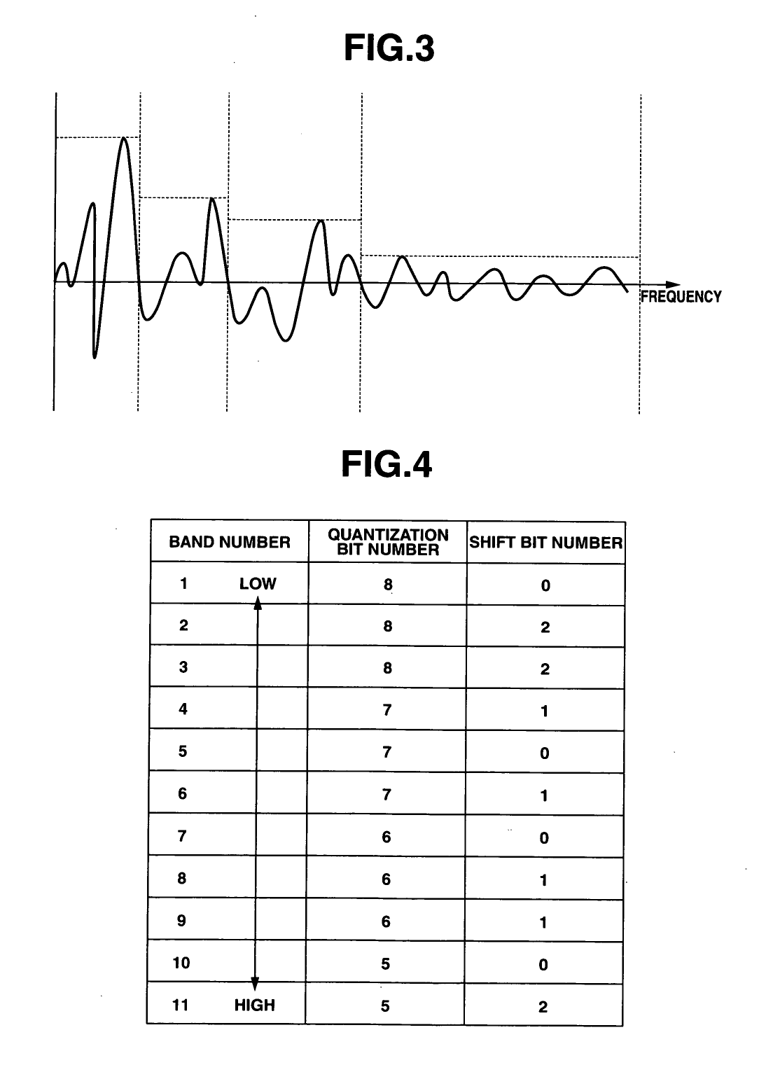

The band dividing unit 2 divides the frequency band of the frequency transformation factor input from the frequency converting unit 1 according to a property of an auditory sense of human being. Specifically, as shown in FIG. 3, the band dividing unit 2 divides the frequency transformation factor into the narrower, the lower band (the lower frequency band), and into the broader, the higher band (the higher frequency band). For example, in the case where a sampling frequency of the audio signal is 16 KHz, the band dividing unit 2 divides the frequency transformation factor into eleven bands so that a threshold of division is 187.5 Hz, 437.5 Hz, 687.5 Hz, 937.5 Hz, 1,312.5 Hz, 1,687.5 Hz, 2,312.5 Hz, 3,250 Hz, 4,625 Hz, and 6,500 Hz.

The highest value searching unit 3 retrieves the highest value from among absolute values of the frequency transformation factors included in each of the divided bands divided by the band dividing unit 2.

The shift number calculating unit 4 calculates the number of bits to be shifted (hereinafter, referred to as a shift bit number) so that the highest value of the frequency transformation factor in each divided band obtained by the highest value searching unit 3 is not more than the quantization bit number that has been set in advance in each divided band. It is preferable that the quantization bit number that has been set in advance in each divided band is the more in the lower band, and the less in the higher band according to a property of an auditory sense of human being. As shown in FIG. 4, from the lower band to the higher band, the quantization bit number about 8 to 5 bits is allocated. For example, in the case where the highest value in a certain band is “1010 1011 (a binary notation)” and the quantization bit number that has been set in advance in this band is 6, the shift bit number becomes 2.

The shift processing unit 5 shifts the values of all the frequency transformation factors in each of the divided bands by the shift bit number that is calculated by the shift number calculating unit 4. Further, upon decoding, it is necessary to reproduce the frequency transformation factor with the original bit number, so that the data representing the shift bit number for each divided band should be output as a part of a coded signal.

The coding unit 6 codes the data processed by the shift processing unit 5 by a certain coding system and outputs it as the coded signal. Here, as the coding system, various coding systems such as a Huffman coding, and a vector quantization or the like can be applied.

In FIG. 2, an audio decoding apparatus 101 according to the first embodiment is illustrated. The audio decoding apparatus 101 decodes a signal coded by the audio coding apparatus 100, and as shown in FIG. 2, the audio decoding apparatus 101 comprises a decoding unit 7, a shift processing unit 8, and a frequency inverse converting unit 9.

The decoding unit 7 decodes the coded signal including the shift bit number for each divided band that is coded and the coded frequency transformation factor and outputs a result of decoding to the shift processing unit 8.

The shift processing unit 8 shifts the data of the frequency transformation factor that is decoded by the decoding unit 7 by the bit number that is shifted upon coding for each band in a direction opposite to that upon the coding and outputs it to the frequency inverse converting unit 9.

The frequency inverse converting unit 9 performs the frequency inverse transformation (for example, the inverse MDCT) with respect to the data which is shifted by the shift processing unit 8 to transform the data in a frequency domain into a signal in a time domain and outputs the result of the frequency inverse transformation as a reproduction signal.

Next, the operation in the first embodiment will be described.

At first, with reference to the flow chart shown in FIG. 5, the audio coding processing to be carried out by the audio coding apparatus 100 will be described.

The input audio signal in a time domain is converted into a signal in a frequency domain (step S1), and the frequency transformation factor obtained by the frequency transformation is divided into the narrower, the lower band, and into the broader, the higher band according to a property of an auditory sense of human being (step S2). Subsequently, the highest value of the absolute values of the frequency transformation factors is searched for each divided band (step S3) and the shift bit number is calculated so that the highest value of each band is not more than the quantization bit number that has been set in advance in each band (step S4).

The shift processing is applied to all frequency transformation factors in the divided band for each divided band by the shift bit number calculated in step S4 (step S5) and the data after the shift processing is coded by a predetermined coding system (step S6). Thus, the audio coding processing is finished.

The shift bit number is added to the coded signal as the data in the order of the divided band, and it is stored in a memory in the audio coding apparatus 100 or output to the other apparatus.

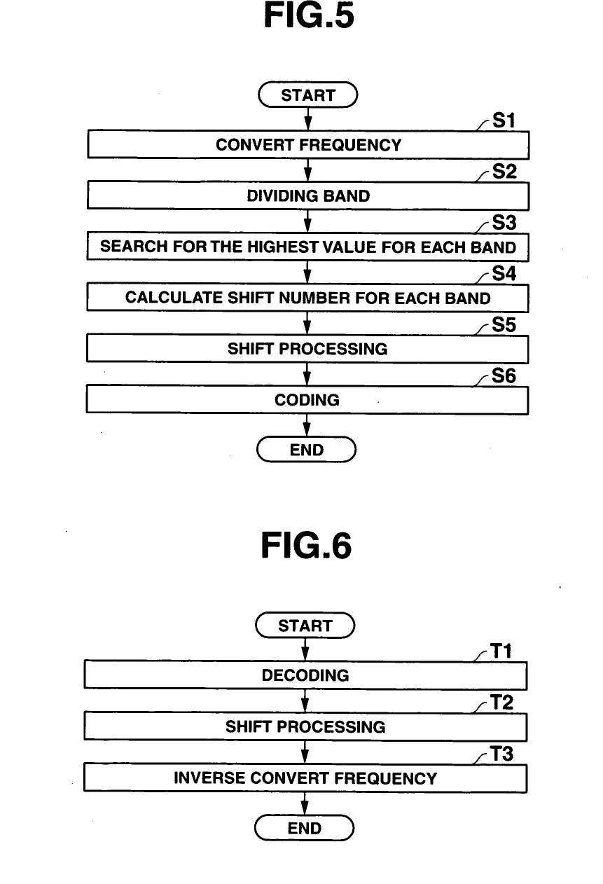

Next, with reference to the flow chart shown in FIG. 6, the audio decoding processing to be carried out in the audio decoding apparatus 101 that decodes the coded audio signal made by the audio decoding apparatus will be described.

At first, the input coded signal is decoded (step T1). Then, the decoded frequency transformation factor data for each divided band is shifted in a direction opposite to that upon the coding by the bit number shifted upon the coding for each band (step T2). The frequency of the shifted frequency transformation factor data is inversely converted (step T3), and thus, the decoding processing is finished.

As described above, according to the first embodiment, by dividing the band of the audio signal according to a property of an auditory sense of human being and shifting the frequency transformation factor so that it is not more than the quantization bit number that has been set in advance, it is possible to improve the processing speed of the audio coding.

Other embodiments of an audio coding apparatus and an audio decoding apparatus according to the present invention will be described. The same portions as those of the first embodiment will be indicated in the same reference numerals and their detailed description will be omitted.

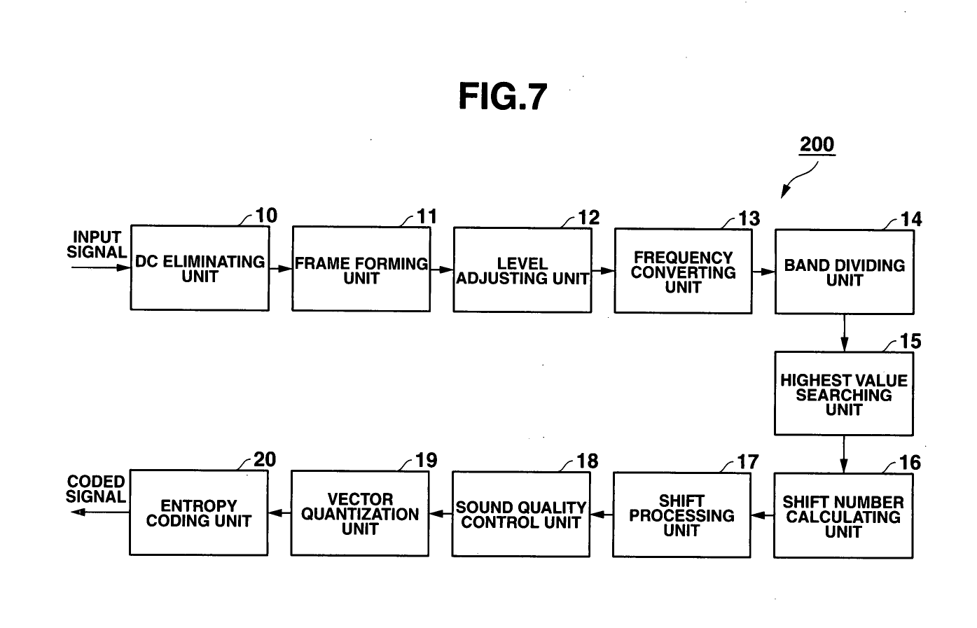

With reference to FIGS. 7 to 10, a second embodiment of the present invention will be described below.

FIG. 7 shows a configuration of an audio coding apparatus 200 according to the second embodiment. The audio coding apparatus 200 comprises a direct current (DC) eliminating unit 10, a frame forming unit 11, a level adjusting unit 12, a frequency converting unit 13, a band dividing unit 14, a highest value searching unit 15, a shift number calculating unit 16, a shift processing unit 17, a sound quality control unit 18, a vector quantization unit 19, and an entropy coding unit 20.

Among the component parts of the audio coding apparatus 200, the frequency converting unit 13, the band dividing unit 14, the highest value searching unit 15, the shift number calculating unit 16, and the shift processing unit 17 have the same functions as those of the frequency converting unit 1, the band dividing unit 2, the highest value searching unit 3, the shift number calculating unit 4, and the shift processing unit 5 of the audio decoding apparatus 100 according to the first embodiment, respectively, so that the explanations of their functions are herein omitted.

The DC eliminating unit 10 eliminates a direct current component of the input audio signal and outputs the result of elimination to the frame forming unit 11. The direct current component of the audio signal is removed because the direct current component has little to do with the sound quality. For example, removal of the direct current component can be realized by a high-frequency pass filter. For example, there is a high-frequency pass filter that can be represented by the formula (3).

$$H ( z ) = \frac{0.464 - 0.927 {z}^{- 1} + 0.464 {z}^{- 2}}{1 - 1.906 {z}^{- 1} + 0.911 {z}^{- 2}} \qquad ( 3 )$$

The frame forming unit 11 divides the signal input from the DC eliminating unit 10 into frames with a predetermined length that are a processing unit of coding (compression) and outputs the frames to the level adjusting unit 12. Here, the frame is made into a length that includes one or more blocks. One block is a unit for carrying out one modified discrete cosine transform (MDCT) and it has a length by the order of the MDCT. A tap length of the MDCT is ideally a length of 512 taps.

The level adjusting unit 12 carries out the level adjustment (the amplitude adjustment) of the input audio signal and outputs the level-adjusted signal to the frequency converting unit 13. The level adjustment serves to make the highest value of the amplitude of the signal included in one frame to fall in the designated bit (hereinafter, a suppressed target bit). It is conceivable that the audio signal is suppressed to about 10 bits. Assuming that the highest amplitude of the signal in one frame is n bit, and the suppressed target bit is N, the level adjustment can be realized by shifting all the signals in the frame to the side of LSB (Least Significant Bit) by the number of shift_bits satisfying the formula (4).

$$shift\_bit = \{ \begin{matrix} 0 & ( n \leq N ) \\ N - n & ( n > N )\end{matrix} \qquad ( 4 )$$

Further, at the time of decoding, it is necessary to reproduce the original signal, amplitude of which is suppressed not more than the suppressed target bit, so that it is also necessary to output a signal representing shift_bit as a part of the coded signal.

As the processing of the audio coding apparatus 100 according to the first embodiment, the frequency of the level-adjusted signal is converted by the frequency converting unit 13, and the frequency transformation factor obtained by the frequency transformation processing is divided according to a property of an auditory sense of human being by the band dividing unit 14. Subsequently, the highest value of the absolute values of the frequency transformation factors is searched for each divided band by the highest value searching unit 15, and the shift bit number is calculated by the shift number calculating unit 16 so that the highest value of the frequency transformation factor in each divided band is not more than the quantization bit number that has been set in advance in each divided band. Then, the shift processing unit 17 shifts all the frequency transformation factors in each divided band by the shift bit number calculated by the shift number calculating unit 16.

The sound quality control unit 18 carries out the sound quality control by selectively deleting band data of the frequency transformation factor so as to control whether the quality of a reproduced audio is improved although the coding data volume is increased or the coding data volume is decreased although the quality of the reproduced audio is sacrificed to some extent. In other words, it has been determined in advance in how many bands the factor is coded among the frequency transformation factors in order to obtain a predetermined sound quality. Then, in the case where the data number of the frequency transformation factor after the shift processing is more than the data number (the band number of the coding target) that has been determined in advance, the frequency transformation factors in the excess band are deleted to output the frequency transformation factors of the remaining bands to the vector quantization unit 19. For example, according to a certain method of the deleting processing, the frequency transformation factors of the band having a small energy are deleted at first.

A specific example will be explained assuming that the MDCT factors of one block are 16 bands and the number of bands of the coding target is 10. If the MDCT factors of 16 bands are 10, −5, 80, 657, −324, −2, 986, 324, −832, 27, −31, 89, 2, −1, 9, and 1, the MDCT factors (−5, −2, 2, −1, 9, and 1) of the second, the sixth, the thirteenth, the fourteenth, the fifteenth, and the sixteenth bands with the small energy are deleted and the MDCT factors of the remaining ten bands become the coding targets. Further, upon decoding, in order to reproduce the data of the deleted band, the signal indicating which band is coded should be also output as a part of the coded signal.

The vector quantization unit 19 has a vector quantization (VQ) table storing a representative vector indicating a plurality of sound patterns therein, compares a frequency transformation factor (vector) Fⱼ of the coding target input from the sound quality control unit 18 with each representative vector stored in the VQ table, and outputs an index indicated by the representative vector that is the most similar to Fⱼ to the entropy coding unit 20 as a code.

For example, assuming that a vector of a coding target of a vector length N is {sⱼ|j=1, . . . , N} and k pieces of representative vectors stored in the VQ table are {Vᵢ|i=1, . . . , k}, and Vᵢ={Vᵢⱼ|j=1, . . . , N}, i (an index) such that an error eᵢ of each element Vᵢⱼ of the i-th representative vector stored in the VQ table becomes the smallest is defined as a code to be output. The error eᵢ can be calculated by the following formula (5).

$${e}_{i} = {\sum }_{j = 1}^{N} {( {s}_{j} - {v}_{ij} )}^{2} \qquad ( 5 )$$

The number of the representative vectors k and a vector length N are determined in consideration of a time required for processing of the vector quantization and a capacity of the VQ table or the like. For example, various combinations such as the vector length 3 and the representative vector number 128 or the vector length 4 and the representative vector number 256 are available. In addition, by preparing the VQ table that is different for each band of the coding target, it is possible to improve the quality of the reproduced sound.

The entropy coding unit 20 performs the entropy coding with respect to the data input from the vector quantization unit 19 and outputs the result of coding as a coded signal. The entropy coding is a coding system that makes the entire code length shorter by allocating a short code to the code that frequently appears and a long code to the code that rarely appears by using a statistical property of a signal, and there are a Huffman coding, an arithmetic coding, a coding by a Range Coder or the like.

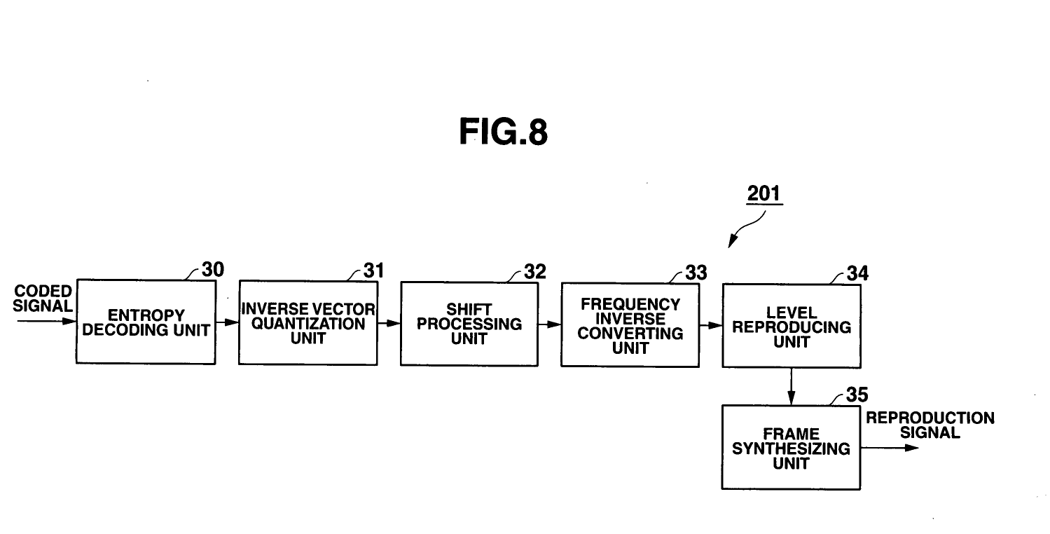

FIG. 8 illustrates the configuration of an audio decoding apparatus 201 according to the second embodiment of the present invention. The audio decoding apparatus 201 decodes the signal coded by the audio decoding apparatus 200. The audio decoding apparatus 201 comprises an entropy decoding unit 30, an inverse vector quantization unit 31, a shift processing unit 32, a frequency inverse converting unit 33, a level reproducing unit 34, and a frame synthesizing unit 35. Among the component elements of the audio decoding apparatus 201, the shift processing unit 32 and the frequency inverse converting unit 33 have the same function as those of the shift processing unit 8 and the frequency inverse converting unit 9 of the audio decoding apparatus 101 according to the first embodiment, respectively, so that the explanations thereof are herein omitted.

The entropy decoding unit 30 decodes the input signal that is entropy-coded and outputs the result of decoding to the inverse vector quantization unit 31.

The inverse vector quantization unit 31 has the VQ table storing the representative vector indicating a plurality of sound patterns therein and extracts a representative vector corresponding to a signal (an index) that is input from the entropy decoding unit 30. In this case, when the number of bands of the current frequency transformation factor is less than the number of bands of the original (before the frequency transformation) frequency transformation factor, the inverse vector quantization unit 31 inserts a predetermined value in the band for the shortfall and outputs the frequency transformation factors for all the bands to the shift processing unit 32. The data value to be inserted in the band for the shortfall is a value that is smaller than the energy value of the band of the input signal (for example, 0).

The level reproducing unit 34 reproduces the level of the signal input from the frequency inverse converting unit 33 into the original level by adjusting the level (the amplitude adjustment) and outputs it to the frame synthesizing unit 35.

The frame synthesizing unit 35 synthesizes a frame that is a processing unit of coding and decoding and outputs the synthesized signal as the reproduction signal.

Next, the operation of the second embodiment will be described.

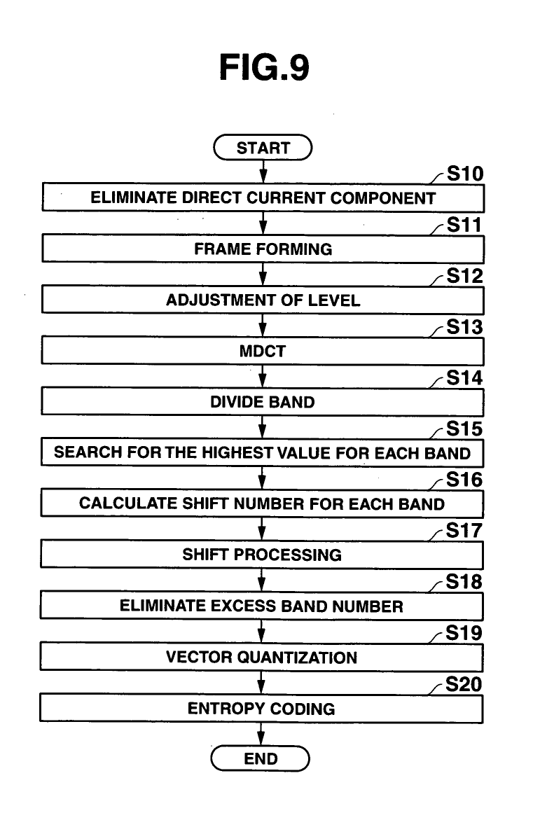

At first, with reference to the flow chart of FIG. 9, the audio coding processing to be carried out by the audio coding apparatus 200 will be described.

The direct current component of the input audio signal is eliminated (step S10) and the audio signal, in which direct component has been eliminated, is divided into a frame with a predetermined length (step S11). Subsequently, the level (the amplitude) of the input audio signal is adjusted for each frame (step S12) and the MDCT processing is performed with respect to the level-adjusted audio signal (step S13).

The MDCT factor (a frequency transformation factor) obtained by the MDCT is divided into bands according to a property of an auditory sense of human being (step S14). Subsequently, the highest value of the absolute value of the MDCT factor is searched for each divided band (step S15), and the number of the shift bits is calculated so that the highest value of the frequency transformation factor in each divided band is not more than the number of the quantization bits that has been set in advance in each band (step S16).

For each divided band, the shift processing is performed with respect to all the MDCT factors in the band by the shift bit number calculated in step S16 (step S17). In the case where the number of the bands of the current MDCT factor is more than the number of the bands that has been designated in advance (the number of the bands for the coding target), the band for the excess is deleted (step S18).

The vector quantization is performed with respect to the MDCT factor of the band of the coding target (step S19) and the entropy processing is performed with respect to the signal after the vector quantization (step S20). Thus, the audio coding processing is finished.

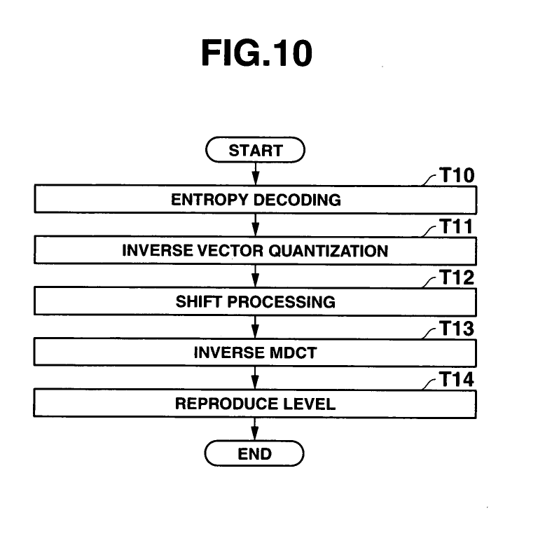

Next, with reference to the flow chart of FIG. 10, the audio decoding processing to be carried out by the audio decoding apparatus 201 will be described.

At first, the coded signal (the entropy coded signal) is decoded (step T10) and the inverse vector quantization is performed with respect to the decoded signal (step T11). Here, in the case where the number of the bands of the current MDCT factor is less than the number of the bands of the original MDCT factor, a predetermined value (for example, 0) is inserted in the band for the shortfall.

With respect to the MDCT factor for all the bands, the shift processing is carried out in the opposite direction by the number of the bits that is shifted upon coding (step T12), and the inverse MDCT is performed with respect to the shifted data (step T13). Subsequently, the level is returned to the original level by the level adjustment of the signal after the inverse MDCT (step T14), and frames that are units of coding and decoding are synthesized. Thus, the audio decoding processing is finished.

As described above, according to the second embodiment, since the frequency transformation factor for the number of the bands that has been designated in advance is defined as the coding target, the coding processing with a higher speed can be realized.

Further, the description in each of the above-described embodiments can be appropriately modified in a scope without deviating from a spirit of the present invention.

For example, according to each of the above-described embodiments, the MDCT is described as an example of the frequency transformation. However, the other frequency transformation such as a discrete Fourier transform (DFT) may be used.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. An audio coding apparatus comprising:
a frequency converting unit which performs a frequency transformation with respect to an input audio signal;
a band dividing unit which divides a frequency band of frequency transformation factors which are obtained by the frequency transformation performed by the frequency converting unit into sub bands, a band width of the sub bands being narrower for a lower frequency sub band and wider for a higher frequency sub band;
a retrieving unit which retrieves one of the frequency transformation factors obtained by the frequency transformation performed by the frequency converting unit for each sub band which has a maximum absolute value;
a shift number calculating unit which calculates a shift bit number so that the one frequency transformation factor retrieved for each sub band by the retrieving unit is not more than a quantization bit number that has been determined in advance in each sub band;
a shift processing unit which performs a shift processing for the shift bit number that is calculated by the shift number calculating unit with respect to the frequency transformation factors obtained by the frequency converting means; and
a coding unit which encodes the frequency transformation factors that are shift-processed by the shift processing unit.

2. The audio coding apparatus according to claim 1, wherein the coding unit comprises:
a vector quantization unit which performs a vector quantization with respect to the frequency transformation factors that are shift-processed by the shift processing unit; and
an entropy coding unit which performs an entropy coding with respect to the vector-quantized data.

3. The audio coding apparatus according to claim 2, further comprising:
an eliminating unit which eliminates a direct current component of the input audio signal;
a frame forming unit which divides the input audio signal from which the direct current component is eliminated by the eliminating unit into frames with a predetermined length; and
an amplitude adjusting unit which adjusts an amplitude of the audio signal included in each frame that is obtained by the frame dividing unit based on a maximum amplitude of the audio signal and outputs the amplitude-adjusted audio signal to the frequency converting unit.

4. The audio coding apparatus according to claim 3, further comprising a band number deleting unit which, when the number of the frequency transformation factors obtained by the frequency transformation is more than the number that has been designated in advance, deletes a number of frequency transformation factors which is more than the designated number.

5. The audio coding apparatus according to claim 4, wherein the frequency converting unit performs a modified discrete cosine transformation.

6. An audio decoding apparatus comprising:
a decoding unit which decodes a coded audio signal including a shift bit number for each of sub bands of frequency transformation factors and a coded frequency transformation factor, the sub bands being obtained by dividing a frequency band of the frequency transformation factors, a band width of the sub bands being narrower for a lower frequency sub band and wider for a higher frequency sub band;
a shift processing unit which shifts the frequency transformation factors decoded by the decoding unit in a direction opposite to a direction upon coding by the decoded shift bit number; and
a frequency inverse converting unit which performs a frequency inverse transformation with respect to the frequency transformation factors shifted by the shift processing unit into a signal in a time domain and outputs the signal.

7. An audio coding method comprising:
performing a frequency transformation with respect to an input audio signal;
dividing a frequency band of frequency transformation factors which are obtained by the frequency transformation into sub bands, a band width of the sub bands being narrower for a lower frequency sub band and wider for a higher frequency sub band;
retrieving one of the frequency transformation factors obtained by the frequency transformation for each sub band which has a maximum absolute value;
calculating a shift bit number so that the one frequency transformation factor retrieved for each sub band is not more than a quantization bit number that has been determined in advance in each sub band;
performing a shift processing for the calculated shift bit number with respect to the frequency transformation factors; and
encoding the shifted frequency transformation factors.

8. The audio coding method according to claim 7, wherein the coding comprises:
performing a vector quantization with respect to the shifted frequency transformation factors; and
performing an entropy coding with respect to the vector-quantized data.

9. The audio coding method according to claim 8, further comprising:
eliminating a direct current component of the input audio signal;
dividing the input audio signal from which the direct current component is eliminated into frames with a predetermined length; and
adjusting an amplitude of the audio signal included in each frame based on a maximum amplitude of the audio signal, the amplitude-adjusted audio signal being subjected to the frequency transformation.

10. The audio coding method according to claim 9, further comprising, when the number of the frequency transformation factors is more than the number that has been designated in advance, deleting a number of frequency transformation factors which is more than the designated number.

11. The audio coding method according to claim 10, wherein the frequency transformation comprises a modified discrete cosine transformation.

12. An audio decoding method comprising:
decoding a coded audio signal including a shift bit number for each of sub bands of frequency transformation factors and a coded frequency transformation factor, the sub bands being obtained by dividing a frequency band of the frequency transformation factors, a band width of the sub bands being narrower for a lower frequency sub band and wider for a higher frequency sub band;
shifting the decoded frequency transformation factors in a direction opposite to a direction upon coding by the decoded shift bit number; and
performing a frequency inverse transformation with respect to the shifted frequency transformation factors into a signal in a time domain and outputs the signal.
